(19) United States
(12) Patent Application Publication
(10) Pub. No.: US 2005/0083147 A1
(43) Pub. Date: Apr. 21, 2005

(54) Circuit board and method in which the impedance of a transmission-path is selected by varying at least one opening in a proximate conductive plane

(76) Inventor: Andrew Harvey Barr, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,066

(22) Filed: Oct. 20, 2003

(51) Int. Cl. H01P 5/02

(52) U.S. Cl. 333/33

(57) ABSTRACT

A device and method for defining a signal transmission path having a selectable, continuous impedance. In one embodiment of the invention, a circuit board is provided with a signal conductor, and a conductive plane having an opening, wherein dimensions of the opening and proximity of the opening to the signal conductor are selected to affect an impedance of the signal conductor. The signal conductor and the conductive plane form a transmission path with the impedance of the transmission path being a function in part of the opening and the signal conductor. Such a circuit board provides a signal-transmission path having a selectable, continuous impedance return-signal path.

### BACKGROUND

The present invention relates generally to the field of printed circuit boards (“PCBs”). More particularly, aspects of the present invention provide a selectable transmission-path impedance that is particularly suitable for high-frequency signals on a printed circuit board.

A driver circuit is typically used to drive an electrical signal onto a signal conductor, such as a trace, which is connected to a receiver circuit. Once the signal reaches the receiver, it requires a return path from the receiver back to the driver and typically follows a path having the least impedance (if there are multiple return paths to choose from). The signal path or loop followed by the signal from driver to receiver, and from receiver back to driver, is referred to herein as a transmission path. A transmission path has a characteristic impedance that is a function of several variables as described below.

Common types of PCBs are a double-sided PCB and a multi-layered PCB. A double-sided PCB includes conductive planes formed on both sides of an insulation layer. A multi-layered PCB includes a plurality of conductive planes and insulation layers. In a multi-layered PCB, an insulation layer is typically formed in between conductive planes. The multi-layered PCB can have three or more conductive planes. The term “conductive planes” herein refers to power planes, reference planes, and/or ground planes. A “transmission path” typically includes a signal conductor, such as a trace from a driver to a receiver, and a conductive plane acting as a return-signal path. A PCB structure provides a transmission path having a characteristic impedance, such as 50 ohms. It is often necessary to provide a higher-impedance transmission path than the characteristic impedance of a PCB structure to impedance match a driver and a receiver. Impedance mismatches produce several detrimental effects in high-frequency circuits, and are to be avoided. Detrimental effects include reflection of a signal between the driver and receiver, ringing on the signal, and electromagnetic interference (“EMI”).

A signal conductor may be formed on a surface of a PCB or within a multi-layer PCB stack-up. FIG. 1 is a perspective view of a multi-layered PCB 10 that includes a buried signal conductor, illustrated as signal trace 20, insulation layers 14, 16, and 18, and conductive planes 30 and 40. The signal trace 20 may be formed on an internal surface of the PCB 10 or, as illustrated, on a layer within the PCB stack-up. This type of PCB structure where the signal trace is buried in the PCB and adjacent to a first and second conductive plane is call a “strip line” construction. The term when the signal trace is on the surface and is adjacent to only a first conductive plane is called a “micro-strip” construction. The conductive planes 30 and 40 of FIG. 1 can be used for any purpose. The insulation layers 14, 16, and 18 may be any type of insulating material known in the art for forming a PCB. For purposes of clarity, a top layer 12 and a bottom layer 13 of the PCB are shown as having been omitted.

The PCB stackup includes the conductive plane 30 formed on top of insulating layer 14. The insulation layer 16 is formed on top of the conductive plane 30. The buried signal trace 20 is formed on top of the insulation layer 16, and has a trace width S. While the trace width S may be any value, trace widths of 0.005 inch are commonly used resulting in an impedance of substantially 50 ohms for typical insulation layer materials and typical spacings between conductive planes and signal traces. The insulating layer has a parameter called dielectric and for different dielectrics, different capacitance and thus Zo is achieved with the same spacing.

Other traces (not shown) may also be formed on the insulation layer 16. The insulation layer 18 is formed on top of the insulation layer 16 and the signal trace 20. The conductive plane 40 is formed on top of the insulation 18, which provides insulation between the conductive plane 40 and the buried signal trace 20, and defines a separation distance D from the nearest surface of the trace 20. The signal trace 20 can be used to conduct a signal from a driver circuit (not shown) to a receiver circuit (not shown), and a plane such as conductive plane 40 can be used to conduct the return signal, forming a transmission path.

In recent years, double-sided and multi-layered PCBs have become increasingly thinner to meet the demand of consumers for smaller and more compact electronic products. One way to reduce PCBs thickness is reducing the thickness of the insulation layers between the conductive planes. However, reducing the thickness of an insulation layer between a signal trace and its conductive plane reduces the separation distance D, and thus the characteristic impedance, of the transmission path.

The characteristic impedance of a signal conductor is primarily determined by inductance and capacitance as shown in equation (1):

$$Zo = \sqrt{\frac{L}{C}} \qquad ( 1 )$$

where Zo is the characteristic impedance of the signal conductor, L is the inductance per unit length of the signal conductor, and C is the capacitance per unit length of the signal conductor. Furthermore, the capacitance per unit length C of the signal conductor is generally expressed as shown in equation (2):
C=KS/D (2)
in which K is the dielectric constant of the insulation layer separating a conductor and its conductive plane, S is the electrode plate size (primarily width of the signal conductor), and D is the distance between two electrode plates, which in this case is the separation distance between the signal conductor and the nearest conductive plane.

When these two equations are combined, the resulting equation is as shown in equation (3):

$$Zo = \sqrt{\frac{LD}{KS}} \qquad ( 3 )$$

According to equation (3), if the inductance per unit length of the signal conductor (L), dielectric constant (K), and the width of the signal conductor (S) remain constant, the characteristic impedance of the signal conductor decreases by decreasing D, the separation distance.

Reduction of the characteristic impedance in the thinner PCBs is typically beneficial because such reduction reduces cross-talk and lessens the effects of EMI on the signal conductors. However in certain applications, the reduction is not beneficial. Some signal conductors, such as video-signal conductors, require higher impedances to match properly with electronic components, such as video displays, that operate with higher impedances. Various techniques have been used to produce high-impedance transmission paths were necessary. These techniques include routing the signal conductor on the surface layer of the PCB. Disadvantages of this technique include a limited amount of board-surface-layer-space available, production difficulties in controlling impedance of a trace on a surface layer, and greater EMI generation by signal conductors on surface layers.

Another technique for producing increased-impedance transmission paths includes routing the signal over signal conductors on internal PCB layers. According to Equation (3), the characteristic impedance of a signal conductor can be increased by keeping the factors L, K, and S constant and increasing D, which is the separation distance between the signal conductor and the conductive plane. This may be accomplished by increasing the thickness of an insulation layer, thereby causing the characteristic impedance of all other signal conductors on the insulation layer to be increased. However, this technique increases the thickness of the PCB rather than decreasing it.

Another technique for increasing the separation distance D includes using a conductive plane positioned several layers away from the signal conductor and evacuating portions of intermediate planes between the signal conductor and the conductive plane in order to increase impedance. A disadvantage of this technique is that currents in the evacuated intermediate planes must flow around the evacuated areas. This may cause additional cross-talk and EMI, induce noise, and reduce signal integrity.

Yet another way to increase the characteristic impedance of a signal conductor, according to Equation (3), is to decrease the width of the signal trace S. For example, the signal trace 20 can be reduced to a width such as 0.003 inch. However, decreasing the width increases the losses of the transmission path because the reduced width increases the trace resistance. In addition, decreasing the width of the signal trace may significantly increase the cost of fabricating a PCB and may violate manufacturing standards.

### SUMMARY

In one embodiment of the invention, a circuit board is provided with a signal conductor, and a conductive plane having an opening, wherein dimensions of the opening and proximity of the opening to the signal conductor are selected to affect an impedance of the signal conductor. The signal conductor and the conductive plane form a transmission path with the impedance of the transmission path being a function in part of the opening and the signal conductor. Such a circuit board provides a signal-transmission path having a selectable, continuous impedance return-signal path.

These and various other features as well as advantages of the present invention will be apparent from a reading of the following detailed description and a review of the associated drawings.

### BRIEF DESCRIPTION OF THE DRAWINGS

FIG. 1 is a perspective view of a conventional multi-layered PCB that includes a buried trace, a plurality of insulation layers, and two conductive planes;

FIG. 2A is a perspective view of a multi-layered PCB that includes a buried signal trace, a plurality of insulation layers, a conductive plane having a continuous opening, and another conductive plane, according to an embodiment of the invention;

FIG. 2B is a partial end view of the multi-layered PCB of FIG. 2A; and

FIG. 3 is a perspective view of a multi-layered PCB that includes a buried-signal trace, a plurality of insulation layers, a conductive plane having two continuous openings, and another conductive plane, according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense.

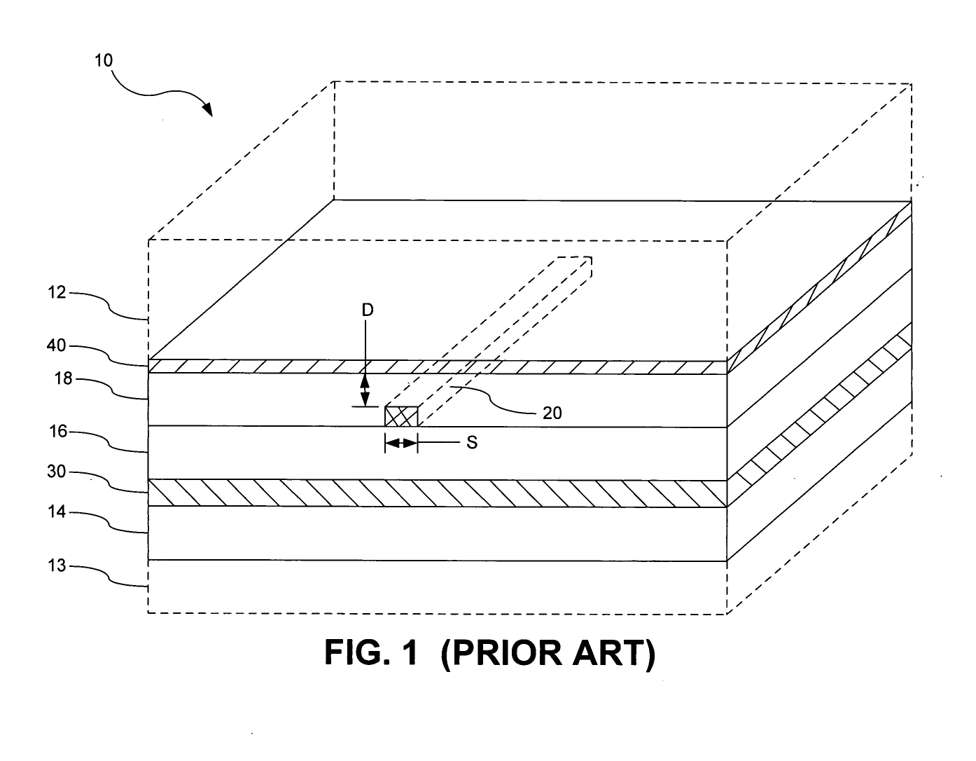

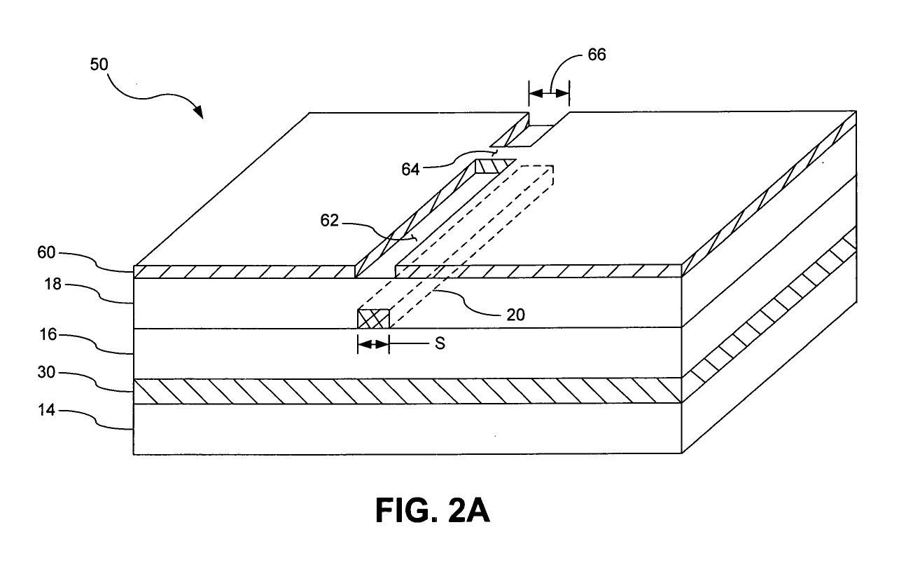

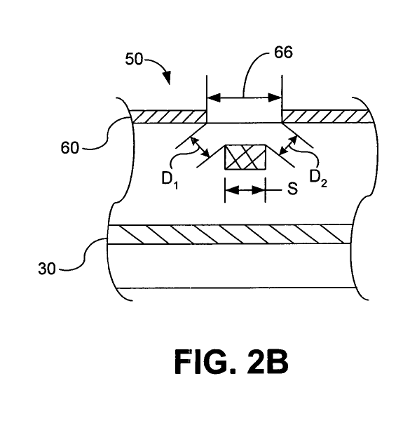

FIG. 2A is a perspective view of a multi-layered PCB 50 that includes a buried signal trace 20, insulation layers 14, 16, and 18, a conductive plane 60 having a continuous opening 62, and another conductive plane 30, according to an embodiment of the invention. For purposes of clarity, any top and bottom layers of the PCB 50 have been omitted. In an alternative embodiment, the signal trace 20 can be on a surface of the PCB 50 and the conductive plane 60 can be buried within the PCB 50. The PCB 50 is substantially similar to the PCB 10 of FIG. 1 with an addition of the continuous opening 62 substantially aligned with the signal trace 20. The conductive plane 60 may be a power, a dedicated reference, or a ground plane.

After the conductive plane 60 is formed on the insulation layer 18, the continuous opening 62 having a width 66 is formed by vacation of the conductive plane 60 in alignment with the route of the signal trace 20. The width 66 may be less than, equal to, or greater than the width S of the signal trace 20. Furthermore, a longitudinal centerline of the opening 62 may or may not coincide with a longitudinal centerline of the trace 20. The signal trace 20 may be partially or fully beneath the conductive plane 60. In an alternative embodiment, another conductive plane such as plane 30 can also have a continuous (not shown) opening aligned with the signal trace 20.

By creating the continuous opening 62, the effective distance between the signal trace 20 and portions of the conductive plane 60 forming the return portion of the transmission path is greater than the distance D of circuit board 10 of FIG. 1. FIG. 2B is a partial end view of the multi-layered PCB 50 of FIG. 2A. Part of the return signal will travel along an edge portion of the plane 60 that is separated from the trace 20 by D1, and the remainder of the return signal will travel along an edge portion of plane 60 that is separated from the trace 20 by distance D2. The effective distance between the trace 20 and the conductive plane 60 is a function of the distances D1 and D2, and is greater than the distance D of FIG. 1. As the width 66 of the opening 62 increases relative to the width S of the trace 20, the greater the distances D1 and D2 become relative to the trace 20, and thus the greater the impedance Zo.

According to equation (3) above, increasing the effective distance (a function of the distances D1 and D2) between the signal trace 20 and the conductive plane 60 increases the impedance Zo of the transmission path. Therefore, by selecting the width 66 and orientation of the continuous opening 62, a PCB designer can advantageously select an impedance Zo that is relatively independent of the thickness of the insulation layer 18. Specifically, the impedance Zo is selected for a given width 66 of the trace 20 by selecting the opening width 66, and the orientation of a longitudinal centerline of the trace 20 relative to a longitudinal centerline of the continuous opening 62. Per equation (3), making the trace 20 wider lowers the transmission-path impedance, and making the opening width 66 wider increases the transmission-path impedance.

This allows the designer to change the resistance of the trace 20 independent of the transmission path impedance Zo. For example, the width S of the trace 20 could be increased over the typical trace width of the PCB to handle increased current, reduce resistive losses, reduce skin effects, or for some other reason. Normally, increasing the width S of the trace 20 decreases the transmission-path impedance. However, the width 66 of the continuous opening 62 can be selected relative the increased width S of the trace 20 to provide a transmission path having a desired impedance Zo that is not otherwise typical of the PCB 50.

The transmission path formed by the trace 20 and the plane 60 (with the opening 62) presents a transmission path having a relatively uniform and continuous impedance, and a small loop area. High-frequency signals are often adversely impacted by impedance discontinuities in the transmission path. The continuous opening 62 allow selection of the impedance Zo presented to signal with little or no degradation of the signal quality or generation of EMI, providing a significant advantage over the prior art.

Another aspect of the invention allows the conductive plane 60 to carry other currents across the opening 62 without adding impedance to or creating a discontinuity in the transmission path formed by the trace 20 and the portions of the conductive plane 60 adjacent to the continuous opening 62. At least one optional bridging conductor 64 may be formed when otherwise vacating the conductive plane 60 to form the continuous opening 62. The bridging conductor 64 is generally formed perpendicular to a longitudinal centerline of the opening 62 and the return-signal path, and electrically couples the conductive plane 60 across the opening 62. While only one bridging conductor 64 is shown across the opening 62, it is generally anticipated that a plurality of bridging conductors 64 may be formed to conduct cross-currents.

The width of the bridging conductor 64 is selected to minimize any tendency of the return signal to include the bridging conductor in the return-signal pathway. Because a signal seeks the lowest impedance path, as the width of the bridging conductor 64 increases, a return signal traveling along the edge portions of the opening 62 will begin to include portions of the bridging conductor 64 in its return path and a lower path impedance will result. Inclusion of significant portions of the bridging conductor 64 in the return-signal path will generate impedance discontinuities, resulting in EMI and signal degradation. To avoid impedance discontinuities or changes, the width of the bridging conductor 64 is selected to provide adequate cross-current pathway across the opening 62 while being too small to provide a significant return-signal pathway for the signal carried on the trace 20. That is, by controlling the width of the bridging conductors 64, the PCB designer can provide adequate paths for cross-currents with negligible effect on the value and continuity of Zo, and with negligible signal degradation and EMI generation.

The dimensions of the elements of the PCB 50 may be varied by a designer to meet intended impedance requirements. For example, if the PCB 50 typically uses a 0.005-inch width S for the trace 20, the width 66 of the opening 62 could be in a range based on the width S. For example, the width 66 could range between 80% and 300% of the width S, which for a 0.005-inch wide trace 20 ranges between 0.004″-0.015.″ If the optional bridging conductors 64 are used, the width of the bridging conductor 64 might be approximately equal to the width S, keeping in mind that whatever bridging-conductor width is selected should not provide a significant return-signal pathway that creates an impedance discontinuity. The number of bridging conductors 64 is typically selected by a designer based on the amount of cross-current anticipated. The bridging connectors 64 are typically equally spaced apart along a longitudinal length of the opening 62, although the spacing may be unequal. For example, the distance between adjacent bridging conductors 64 could be a multiple of the width S or the opening width 66. For example, if the opening width 66 is 0.01 inch, and the multiple is 10 times the opening width 66, the resulting spacing is 0.100 inch between adjacent bridging conductors 64.

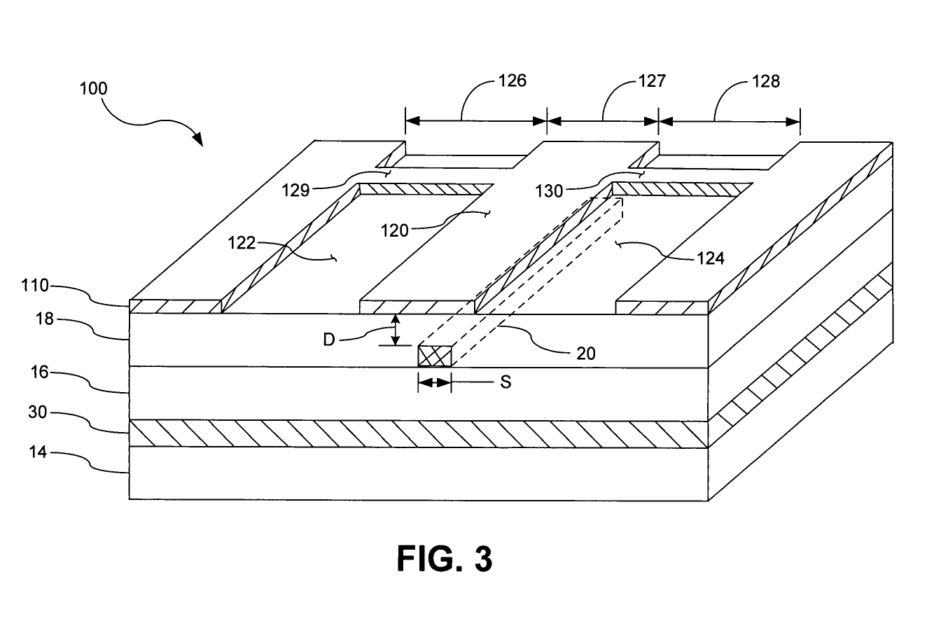

FIG. 3 is a perspective view of a multi-layered PCB 100 that includes a buried-signal trace 20, insulation layers 14, 16, and 18, a conductive plane 110 having a return-signal conductor 120, two continuous openings 122 and 124, and another conductive plane 30, according to an embodiment of the invention. PCB 100 is similar to PCB 50, except that two continuous openings 122 and 124 having widths 126 and 128, respectively, are vacated in the conductive plane 110 to form a return-signal conductor 120 having a width 127 in an alignment with the trace 20. The PCB 50 of FIG. 2 increases return-signal pathway impedance by vacation of a portion of the conductive plane to increase the distance D while leaving the conductive plane 60 essentially of infinite width with respect to the width S of the trace 20. In contrast, the PCB 100 increases the transmission-path impedance by defining a finite width 127 of the return-signal conductor 120. The characteristic impedance Zo of the signal trace expressed in equation (3) now also becomes a function of the width 127 of the return-signal conductor 120. The width 127 may be larger, the same, or smaller than the width S of the trace 20, as necessary to provide a selected impedance and current capacity.

The conductive plane 110 may be used to form a plurality of transmission pathways by referencing a plurality of signal traces. For example, two transmission pathways may be defined in the PCB 100 using the conductive plane 110 by forming two return-signal conductors, each formed in an alignment with a trace in a manner similar to the conductor 120. The two return-signal conductors may each be defined by vacating a respective pair of continuous openings, such as the openings 122 and 124, in an alignment with a different trace formed on the insulation layer 16. Each trace formed on the insulation layer 16 could have a different transmission loop impedance, as defined by a combination of the widths of the continuous openings and the width of its return-signal pathway defined thereby.

As with the PCB 50 of FIG. 2, the width 127 may be less, equal to, or greater than the width S of the signal trace 20. Further, a longitudinal centerline of the width 127 may or may not coincide with a longitudinal centerline of the trace width S. In an alternative embodiment, another conductive plane such as plane 30 can also have a continuous (not shown) opening aligned with the signal trace 20. Also, as with the PCB 50, optional bridging conductors may be formed across the openings 122 and 124 by leaving portions of the conductive plane 110 when otherwise vacating the continuous openings 122 and 124.

Moreover, if the openings 122 and 124 are narrow enough, then the return signal may also travel along one or both edges of the plane 110 in addition to returning along the conductor 120. Therefore, the widths 126 and 128 can also be selected to set Zo at a desired value.

Further, as with the PCB 50 of FIG. 2, the PCB 100 may include one or more bridging conductors across the openings 122 and 124 to conduct cross-currents.

A printed circuit board utilizing aspects of the invention may be used in any electrical system to provide a transmission path having a selectable, continuous impedance, particularly systems involving high-frequency signals, such as computer systems.

Although the present invention has been described in considerable detail with reference to certain preferred embodiments, other embodiments are possible. Therefore, the spirit or scope of the appended claims should not be limited to the description of the embodiments contained herein. It is intended that the invention resides in the claims.

1. A circuit board, comprising:
a signal conductors;
a conductive plane having an opening, wherein dimensions of the opening and proximity of the opening to the signal conductor are selected to affect an impedance of the signal conductor, and
a bridging conductor that electrically couples the conductive plane across the opening and that has a width dimensioned to provide a current pathway that presents a negligible impedance discontinuity to a signal flowing generally parallel to the opening.

2. The circuit board of claim 1, wherein signal conductor has a width, and the opening has a width greater than the signal conductor width.

3. The circuit board of claim 1, wherein the signal conductor is centered with respect to the opening.

4. The circuit board of claim 1, wherein a portion of the opening overlaps the signal conductor.

5. The circuit board of claim 1, wherein no portion of the opening overlaps the signal conductor.

6. The circuit board of claim 1, wherein the signal conductor and the conductive plane form at least a portion of a signal-transmission path.

7. The circuit board of claim 6, wherein the transmission path presents substantially uniform impedance to a high-frequency signal.

8. The circuit board of claim 7, wherein the impedance of the transmission path is a function of the opening width.

9. The circuit board of claim 7, wherein the signal conductor has a width, and the impedance of the transmission path is a function of the signal conductor width.

10. The circuit board of claim 1, wherein the opening is substantially parallel to the signal conductor.

11. The circuit board of claim 1, wherein the opening is continuous.

12-13. (canceled)

14. The circuit board of claim 1, further including an insulating layer between the signal conductor and the conductive plane.

15. The circuit board of claim 1, wherein the signal conductor comprises a trace.

16. The circuit board of claim 1, wherein the signal conductor is inside a circuit board.

17. A circuit board, comprising:
a signal conductor disposed in a first plane;
a conductive plane having a first and second conductive regions disposed in a second plane;
a first opening disposed in the second plane, substantially parallel to the signal conductor, and contiguous with and disposed between the first and second conductive regions;
a third conductive region disposed in the second plane;
a second opening disposed in the second plane, substantially parallel to the signal conductor, and contiguous with and disposed between the second and third conductive regions;
wherein the first, second, and third conductive regions are operable at a common voltage: and
wherein respective dimensions of the first and second openings and a respective proximity of the openings to the signal conductor are selected to affect an impedance of a transmission path formed by the signal conductor and the second conductive region.

18. The circuit board of claim 17, wherein no portion of the first opening is located directly above or beneath the signal conductor.

19. The circuit board of claim 17, wherein the transmission path is formed by the signal conductor and the first, second, and third conductive regions.

20. The circuit board of claim 17, wherein a longitudinal centerline of the second conductive region coincides with a longitudinal centerline of the signal conductor.

21. The circuit board of claim 17, wherein the transmission path presents substantially uniform impedance to a high-frequency signal.

22. The circuit board of claim 17, wherein the impedance of the transmission path is a function of the first opening width.

23. The circuit board of claim 17, wherein the impedance of the transmission path is a function of the second conductive region.

24. The circuit board of claim 17, further including a bridging conductor that electrically couples the first, second, and third conductive regions across the first and second openings.

25. A method of manufacturing a multi-layered printed circuit board that handles a high-frequency signal, comprising the steps of:
forming a signal-conducting trace on a first insulating layer;
forming a second insulating layer adjacent to the first insulating layer;
forming a conductive plane on the second insulating layer;
forming an opening in the conductive plane, wherein dimensions of the opening and proximity of the opening to the signal conductor are selected to affect an impedance of the signal conductor,
forming a bridging conductor across the opening: and
dimensioning the bridging conductor to provide a current pathway that presents a negligible impedance discontinuity to a signal flowing generally parallel to the opening.

26. A method of manufacturing a multi-layered printed circuit board that handles a high-frequency signal, comprising the steps of:
forming a signal-conducting trace on a first insulating layer;
forming a second insulating layer adjacent to the first insulating layer;
forming a conductive plane on the second insulating layer;
forming in the conductive plane a spaced apart first opening and a second opening that are substantially parallel to the signal-conducting trace and that define electrically connected first outer, middle, and second outer regions of the conductive plane, respective dimensions of the openings and respective proximity of the openings to the signal-conducting trace being selected to provide a transmission path formed by the signal-conducting trace and at least the middle region of the conductive plane with a predetermined.

27. The method of claim 26, wherein the signal-conducting trace is aligned with the middle region of the conductive plane.

28. A method of conducting a high-frequency signal in a circuit board, comprising the steps of:
transmitting the high-frequency signal along a signal conductor disposed in a first plane of the circuit board; and
returning the high-frequency signal along a first conductive region in a second plane that also includes a second conductive region separated from the first conductive region by a first opening and a third conductive region separated from the first conductive region by a second opening, the first, second, and third conductive regions at a common voltage,
dimensions of the openings and proximity of the openings to the signal conductor defining an impedance experienced by the signal.

29. (canceled)

30. An electronic system, comprising:
a circuit board, comprising:
a signal conductor.
a conductive plane having an opening, wherein dimensions of the opening and proximity of the opening to the signal conductor are selected to affect an impedance of the signal conductor, and
a bridging conductor that electrically couples the conductive plane across the opening and that has a width dimensioned to provide a current pathway that presents a negligible impedance discontinuity to a signal flowing generally parallel to the opening.

31. A system, comprising:
a circuit board, comprising:
a signal conductor disposed in a first plane,
first and second conductive regions disposed in a second plane,
a first opening disposed in the second plane, substantially parallel to the signal conductor, and contiguous with and disposed between the first and second conductive regions.
a third conductive region disposed in the second plane.
a second opening disposed in the second plane, substantially parallel to the signal conductor, and contiguous with and disposed between the second and third conductive regions.
wherein the first, second, and third conductive regions are operable at a common voltage, and
wherein respective dimensions of the first and second openings and a respective proximity of the openings to the signal conductor are selected to affect an impedance of a transmission path formed by the signal conductor and the second conductive region.

32. The circuit board of claim 1 wherein the signal trace is disposed in a plane that is separate from and parallel to the conductive plane.
